(19) United States
(12) Patent Application Publication
(10) Pub. No.: US 2009/0213190 A1
(43) Pub. Date: Aug. 27, 2009

(54) METHOD OF MANUFACTURING OF A LIQUID JET HEAD, A METHOD OF MANUFACTURING OF A PIEZOELECTRIC ELEMENT AND A LIQUID JET APPARATUS

(75) Inventor: Xin-shan Li, Shiojiri-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/370,888

(22) Filed: Feb. 13, 2009

(30) Foreign Application Priority Data
Feb. 14, 2008 (JP) 2008-033793
Dec. 24, 2008 (JP) 2008-328146

(51) Int. Cl. B41J 2/045; B21D 53/76

(52) U.S. Cl. 347/72; 29/890.1

(57) ABSTRACT

In a step of heating a piezoelectric precursor film, piezoelectric films are formed one by one on each of plurality of flow passage forming substrate wafers constituting a flow passage forming substrate wafer group, and an order of the flow passage forming substrate wafers for starting the heating of the piezoelectric precursor film is varied by the predetermined number of wafers of the flow passage forming substrate wafer group.

### CROSS REFERENCE TO RELATED APPLICATIONS

The entire disclosure of Japanese Patent Application No. 2008-33793, filed Feb. 14, 2008 and Japanese Patent Application No. 2008-328146, filed Dec. 24, 2008 are incorporated by reference herein.

### BACKGROUND OF THE INVENTION

1. Field of the Invention

The present invention relates to a method of manufacturing a liquid jet head, a method of manufacturing a piezoelectric element, and a liquid jet apparatus.

2. Description of Related Art

A piezoelectric element used for a liquid jet head or the like is an element in which a dielectric film made of a piezoelectric material having an electro-mechanical transduction function is interposed between two electrodes. For example, the dielectric film is made of a crystallized piezoelectric ceramics. Such a piezoelectric element is used as pressure generating means for ejecting a liquid from nozzle openings of a liquid jet head.

A method of manufacturing the piezoelectric element includes forming a lower electrode film on one surface of a substrate (a flow passage forming substrate) by a sputtering method, forming a piezoelectric layer on the lower electrode film by a sol-gel method or an MOD method, forming an upper electrode film on the piezoelectric layer by a sputtering method, and patterning the piezoelectric layer and the upper electrode film to from the piezoelectric element.

The piezoelectric layer is formed so as to have a predetermined thickness in such a manner that piezoelectric films are laminated by repeatedly performing a process of forming the piezoelectric films crystallized by heating of a piezoelectric precursor film in a heating apparatus several times.

When the piezoelectric film is formed by baking the piezoelectric precursor film, the piezoelectric films is formed one by one on each of flow passage forming substrate wafers of a flow passage forming substrate wafer group constituted by the plurality of flow passage forming substrate wafers. That is, after a first piezoelectric film is sequentially formed on each of the flow passage forming substrate wafers, a second piezoelectric film is sequentially formed on each of the flow passage forming substrate wafer.

However, since a deviation occurs in heat history obtained at the time of performing heat processing between the plurality of flow passage forming substrate wafers, a problem may occur in that a difference is caused in piezoelectric characteristics such as an anti-electric field and leakage current of the piezoelectric layer or characteristics such as the sheet resistance of the simultaneously heated lower electrode.

When the piezoelectric film is formed on the flow passage forming substrate wafer, a deviation is caused due to heat history obtained at the time of performing heat processing in an in-plane direction of the flow passage forming substrate wafer. Therefore, a problem may occur in that a difference occurs in the piezoelectric characteristics such as the anti-electric field and the leakage current of the piezoelectric layer in the plane of the flow passage forming wafer or the characteristics such as the sheet resistance of the simultaneously heated lower electrode.

Due to the difference in the displacement characteristics of the piezoelectric element, a problem may occur in that a difference occurs in liquid ejection characteristics of each liquid jet head when the liquid jet heads each having one chip size are formed by dividing the flow passage forming substrate wafer. Moreover, a problem may also occur in that the liquid ejection characteristics cannot be obtained when the plurality of liquid jet heads are mounted on a liquid jet apparatus for use.

Moreover, these problems are caused not only in the method of manufacturing the liquid jet head having the piezoelectric elements but also in a method of manufacturing a piezoelectric element used for other devices.

### SUMMARY OF THE INVENTION

The invention is devised in order to solve at least some of the above-mentioned problems and can be embodied as the following aspects or applied examples.

In order to solve the above-mentioned problems, according to an aspect of the invention, there is provided a method of manufacturing a liquid jet head, comprising the steps of: forming a lower electrode on one surface of a flow passage forming substrate wafer in which a plurality of flow passage forming substrates each provided with pressure generating chambers individually communicating with nozzle openings for ejecting a liquid are integrally formed; forming a piezoelectric layer, in which a plurality of piezoelectric films are laminated by repeatedly performing a step of forming a piezoelectric precursor film to be turned into the piezoelectric film and a step of forming a piezoelectric film has a step of placing the flow passage forming substrate wafer within a heating chamber and a step of heating the piezoelectric precursor film to form the piezoelectric film, on the lower electrode side of the flow passage forming substrate wafer; and forming an upper electrode on the piezoelectric layer. In the step of heating the piezoelectric precursor film, the piezoelectric films are formed one by one on each of the plurality of flow passage forming substrate wafers constituting a flow passage forming substrate wafer group, and an order of the flow passage forming substrate wafers for starting the heating of each piezoelectric precursor film is varied by the predetermined number of wafers of the flow passage forming substrate wafer group.

The features other than the above aspects and objects of the invention are apparent from the description of the specification with reference to the accompanying drawings.

### BRIEF DESCRIPTION OF THE DRAWINGS

In order to understand the invention and the advantages of the invention, the following description and the accompanying drawings will be together referred.

FIG. 1 is an exploded perspective view illustrating the general configuration of a printing head according to the invention.

FIG. 2 is a plan view and a sectional view illustrating the printing head according to the invention.

FIG. 3 is a sectional view illustrating a method of manufacturing the printing head according to the invention.

FIG. 4 is a sectional view illustrating the method of manufacturing the printing head according to the invention.

FIG. 5 is a sectional view illustrating the method of manufacturing the printing head according to the invention.

FIG. 6 is a sectional view illustrating the method of manufacturing the printing head according to the invention.

FIG. 7 is a sectional view illustrating the method of manufacturing the printing head according to the invention.

FIG. 8 is a sectional view illustrating a method of manufacturing the printing head according to a first embodiment of the invention.

FIG. 9 is a sectional view illustrating the method of manufacturing the printing head according to a first embodiment of the invention.

FIG. 10 is a sectional view illustrating a method of manufacturing the printing head according to a second embodiment of the invention.

FIG. 11 is a schematic perspective view illustrating a printing apparatus according to an embodiment of the invention.

### DESCRIPTION OF THE PREFERRED EMBODIMENTS

At least the following is apparent from the description of the specification and the description of the accompanying drawings.

In order to solve the above-mentioned problems, according to an aspect of the invention, there is provided a method of manufacturing a liquid jet head. The method includes the steps of: forming a lower electrode on one surface of a flow passage forming substrate wafer in which a plurality of flow passage forming substrates each provided with pressure generating chambers individually communicating with nozzle openings for ejecting a liquid are integrally formed; forming a piezoelectric layer, in which a plurality of piezoelectric films are laminated by repeatedly performing a step of forming a piezoelectric precursor film to be turned into the piezoelectric film and a step of forming a piezoelectric film has a step of placing the flow passage forming substrate wafer within a heating chamber and a step of heating the piezoelectric precursor film to form the piezoelectric film, on the lower electrode side of the flow passage forming substrate wafer; and forming an upper electrode on the piezoelectric layer. In the step of heating the piezoelectric precursor film, the piezoelectric films are formed one by one on each of the plurality of flow passage forming substrate wafers constituting a flow passage forming substrate wafer group, and an order of the flow passage forming substrate wafers for starting the heating of each piezoelectric precursor film is varied by the predetermined number of wafers of the flow passage forming substrate wafer group.

According this aspect, heat history of the piezoelectric film and the simultaneously heated lower electrode can be made uniform by varying the order of the substrates for starting the formation of each piezoelectric film, comparing to a case of starting the formation typically from a predetermined flow passage forming substrate wafer as the flow passage forming substrate wafer in which the formation of each piezoelectric film is started. Accordingly, piezoelectric characteristics of the piezoelectric elements can be made uniform in the liquid jet heads separated from the plurality of flow passage forming substrate wafers, and thus liquid ejection characteristics can be made uniform.

Here, when the flow passage forming substrate wafer group is constituted by the flow passage forming substrate wafers of which the number is equal to or smaller than the number of piezoelectric films laminated on each of the flow passage forming substrate wafers, it is preferable that the order of the flow passage forming substrate wafers for starting the heating of each piezoelectric precursor film is varied by one wafer of the flow passage forming substrate wafer group. With such a configuration, since a temperature condition within the heating chamber is uniform at the time of starting the formation of the piezoelectric film and at the time of ending the formation of the piezoelectric film, it is possible to form the piezoelectric element having uniform characteristics on the plurality of flow passage forming substrate wafers.

Moreover, when the flow passage forming substrate wafer group is constituted by the flow passage forming substrate wafers of which the number is an n (where n is an integer) multiple of the number of piezoelectric films laminated on each of the flow passage forming substrate wafers, it is preferable that the order of the flow passage forming substrate wafers for starting the heating of each piezoelectric precursor film is varied by the n number of wafers of the flow passage forming substrate wafer group. With such a configuration, since the temperature condition within the heating chamber is uniform at the time of starting the formation of the piezoelectric film and at the time of ending the formation of the piezoelectric film, it is possible to form the piezoelectric element having uniform characteristics on the plurality of flow passage forming substrate wafers.

In the step of laminating the piezoelectric films, it is preferable that the flow passage forming substrate wafer is rotated at a predetermined angle in an in-plane direction of the flow passage forming substrate wafer to be disposed within the heating chamber in the heating of each piezoelectric precursor film. With such a configuration, since the heat history of the piezoelectric films and the lower electrode in the plane of the flow passage forming substrate wafer can be made uniform, the characteristics of the piezoelectric elements in the plane of the flow passage forming substrate wafer can be made uniform.

In the step of laminating the piezoelectric films, it is preferable that the flow passage forming substrate wafer is heated within the heating chamber while being rotated in an in-plane direction of the flow passage forming substrate wafer. With such a configuration, the heat history of the piezoelectric films and the lower electrode in the plane of the flow passage forming substrate wafer can be made uniform more efficiently.

According to another aspect of the invention, there is provided a method of manufacturing a liquid jet head. The method includes the steps of: forming a lower electrode on one surface of a flow passage forming substrate wafer in which a plurality of flow passage forming substrates each provided with pressure generating chambers individually communicating with nozzle openings for ejecting a liquid are integrally formed; forming a piezoelectric layer, in which a plurality of piezoelectric films are laminated by repeatedly performing a step of forming a piezoelectric precursor film to be turned into the piezoelectric film and a step of forming a piezoelectric film has a step of placing the flow passage forming substrate wafer within a heating chamber and a step of heating the piezoelectric precursor film to form the piezoelectric film, on the lower electrode side of the flow passage forming substrate wafer; and forming an upper electrode on the piezoelectric layer. In the step of laminating the piezoelectric films, the flow passage forming substrate wafer is rotated at a predetermined angle in an in-plane direction of the flow passage forming substrate wafer to be arranged within the heating chamber in the heating of each piezoelectric precursor film.

According to this aspect, since the heat history of the piezoelectric films and the lower electrode in the plane of the flow passage forming substrate wafer can be made uniform, the characteristics of the piezoelectric elements in the plane of the flow passage forming substrate wafer can be made uniform, and thus the liquid ejection characteristics can be also made uniform.

According to still another aspect of the invention, there is provided a liquid jet apparatus including the liquid jet head according the above aspects. With such a configuration, it is possible to embody the liquid jet apparatus capable of realizing uniformity of the liquid ejection characteristics by allowing the piezoelectric characteristics to be uniform. Moreover, it is possible to easily control the liquid jet head capable of realizing uniformity of the liquid ejection characteristics.

According to still another aspect of the invention, there is provided a method of manufacturing a piezoelectric element. The method includes the steps of: forming a lower electrode on a substrate; forming a piezoelectric layer, in which a plurality of piezoelectric films are laminated by repeatedly performing a step of forming a piezoelectric precursor film to be turned into the piezoelectric film and a step of forming a piezoelectric film has a step of placing the substrate within a heating chamber and a step of heating the piezoelectric precursor film to form the piezoelectric film, on the lower electrode of the substrate; and forming an upper electrode on the piezoelectric layer. In the step of heating the piezoelectric precursor film, the piezoelectric films are formed one by one on each of the plurality of substrates constituting a substrate group, and an order of the substrates for starting the heating of each piezoelectric precursor film is varied by the predetermined number of substrates of the substrate group.

According to this aspect, the heat history of the piezoelectric films and the simultaneously heated lower electrode can be made uniform by varying the order of the substrates for starting the formation of the piezoelectric film, as the substrate in which the formation of each piezoelectric film is started, compared to a case of starting the formation of each piezoelectric film typically from a predetermined substrate. Accordingly, the piezoelectric characteristics of the piezoelectric elements can be made uniform between the plurality of substrates.

According to still another aspect of the invention, there is provided a method manufacturing a piezoelectric element. The method includes the steps of: forming a lower electrode on a substrate; forming a piezoelectric layer, in which a plurality of piezoelectric films are laminated by repeatedly performing a step of forming a piezoelectric precursor film to be turned into the piezoelectric film and a step of forming a piezoelectric film has a step of placing the substrate within a heating chamber and a step of heating the piezoelectric precursor film to form the piezoelectric film, on the lower electrode of the substrate; and forming an upper electrode on the piezoelectric layer. In the step of laminating the plurality of piezoelectric films, the substrate is rotated at a predetermined angle in an in-plane direction of the flow passage forming substrate wafer to be disposed within the heating chamber in the heating of each piezoelectric precursor film.

According to this aspect, since the heat history of the piezoelectric films and the lower electrode in the plane of the substrate can be made uniform, the characteristics of the piezoelectric elements in the plane of the substrate can be made uniform.

Hereinafter, exemplary embodiments of the invention will be described with reference to the drawings. The embodiments described below are just described as examples of the invention and all constituent elements described below are not essential constituent elements.

### PREFERRED EMBODIMENT

Hereinafter, the embodiments will be described with reference to the drawings.

### (Ink Jet Printing Head)

First, the basic configuration of an ink jet printing head as an example of a liquid jet head according to the invention will be described.

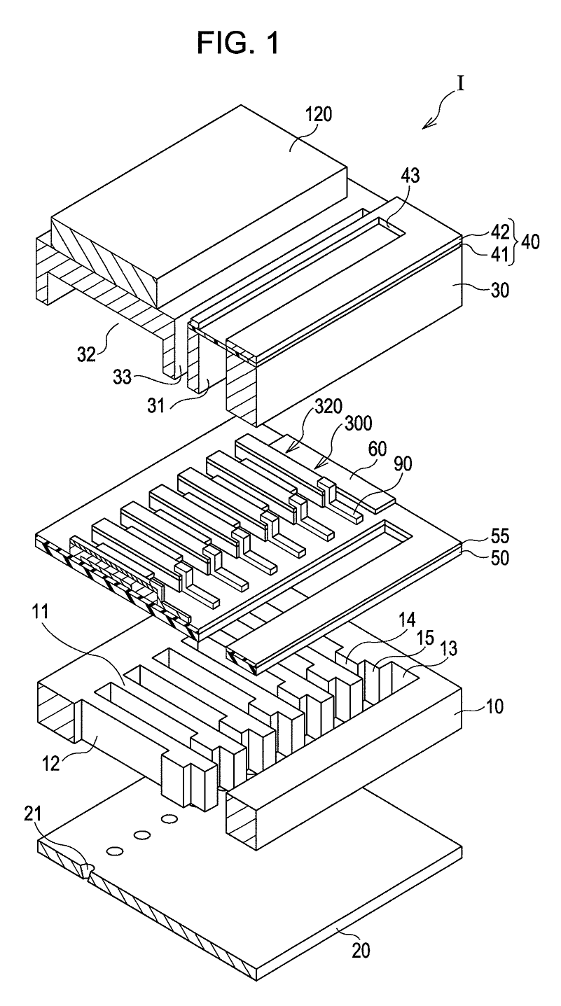

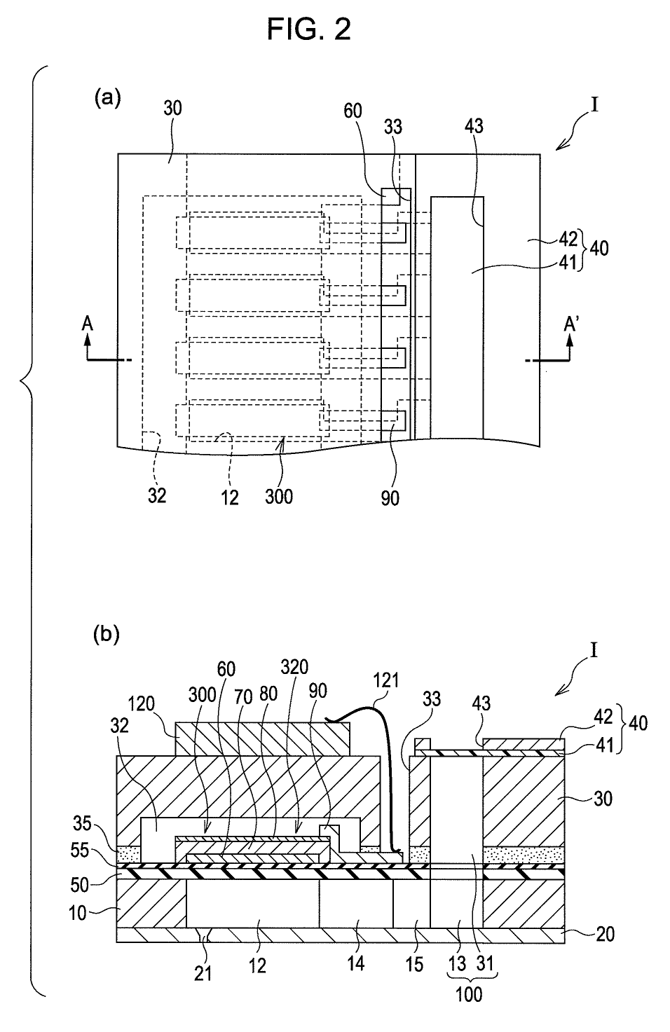

FIG. 1 is an exploded perspective view illustrating the general configuration of the ink jet printing head according to a first embodiment of the invention. FIG. 2 is a plan view of FIG. 1 and a sectional view taken along the line A-A′ of the plan view.

As illustrated, a flow passage forming substrate 10 is formed of a silicon single crystal substrate. An elastic film 50 made of silicon dioxide is formed on one surface of the flow passage forming substrate.

The flow passage forming substrate 10 is provided with a plurality of pressure generating chambers 12 formed in parallel in a width direction of the flow passage forming substrate. A communication section 13 is formed in an outside area in a longitudinal direction of the pressure generating chambers 12 of the flow passage forming substrate 10. The communication section 13 and the pressure generating chambers 12 communicate with each other through ink supply passages 14 and communication passages 15 individually provided in the pressure generating chambers 12. The communication section 13 communicating with a reservoir section 31 of a protective substrate described below forms a part of a reservoir serving as a common ink chamber of the pressure generating chambers 12. Each of the ink supply passages 14 is formed so as to have a width narrower than that of the pressure generating chamber 12 and uniformly maintains a flow resistance of ink flowing from the communication section 13 to the pressure generating chamber 12. In this embodiment, the ink supply passage 14 is formed by narrowing the width of the flow passage from one side, but may be formed by narrowing the width of the flow passage from both sides. Alternatively, the ink supply passage may be formed not by narrowing the width of the flow passage but by narrowing the flow passage in a thickness direction.

A nozzle plate 20 having nozzle openings 21 punched therethrough and individually communicating with the vicinities of the ends of the pressure generating chambers 12 opposite the ink supply passages 14 is fixed and adhered to an opening surface of the flow passage forming substrate 10 by an adhesive, a heat welding film, or the like. The nozzle plate 20 is formed of glass ceramics, a silicon single crystal substrate, or stainless steel, for example.

On the other hand, the elastic film 50 is formed on the side opposite the opening surface of the flow passage forming substrate 10, as described above. An insulating film 55 is formed on the elastic film 50. Additionally, a lower electrode film 60, a piezoelectric layer 70, and an upper electrode film 80 are laminated on the insulating film 55 by a process described below to form each of piezoelectric elements 300. Here, the piezoelectric element 300 refers to a portion containing the lower electrode 60, the piezoelectric layer 70, and the upper electrode film 80. In general, one of the electrodes of the piezoelectric element 300 serves as a common electrode and the other thereof and the piezoelectric layer 70 are patterned in each of the pressure generating chambers 12. In addition, a portion which is formed by the one patterned electrode and the piezoelectric layer 70 and in which piezoelectric deformation occurs by application of voltage to both the electrodes is referred to as a piezoelectric active portion. In this embodiment, the lower electrode film 60 serves as a common electrode of the piezoelectric element 300 and the upper electrode film 80 serves as an individual electrode of the piezoelectric element 300. However, the reverse configuration is also possible depending on the restriction on a driving circuit or wirings. Here, each of the piezoelectric elements 300 and all vibration plates to be displaced by drive of the piezoelectric elements 300 are referred to as an actuator device. In this embodiment, the elastic film 50, the insulating film 55, and the lower electrode film 60 serve as the vibration plate. Of course, the invention is not limited thereto. For example, only the lower electrode film 60 may serve as the vibration plate without providing the elastic film 50 and the insulating film 55. Alternatively, the piezoelectric elements 300 may practically serve as the vibration plate.

The piezoelectric layer 70 is made of a piezoelectric material of which the lower electrode film 60 is formed and which has an electro-mechanical conversion feature. It is preferable that the piezoelectric layer 70 is formed of a crystallization film having a perovskite structure. For example, the ferroelectric material such as lead zirconate titanate (PZT) or a material formed by adding metal oxide such as niobium oxide, nickel oxide, or magnesium oxide to lead zirconate titanate is suitable. Specifically, lead titanate (PbTiO₃), lead zirconate titanate (Pb(Zr, Ti)O₃), lead zirconate acid (PbZrO₃), lead lanthanum titanate ((Pb, La), TiO₃), lead lanthanum zirconate titanate ((Pb, La)(Zr, Ti)O₃), lead magnesium niobate zirconate titanate (Pb(Zr, Ti)(Mg, Nb)O₃), or like can be used. The thickness of the piezoelectric layer 70 is restricted to the extent that crack does not occur in a manufacturing process and is formed so that a sufficient displacement characteristic is achieved. In this embodiment, for example, the thickness of the piezoelectric layer 70 is in the range of about 1 μm to 2 μm.

A lead electrode 90 which is drawn from the vicinity of the end of the ink supply passage 14 and extends up to the insulating film 55 and which is made of gold (Au), for example, is connected to each of the upper electrode film 80 as an individual electrode of the piezoelectric element 300.

A protective substrate 30 having a reservoir section 31 forming at least a part of the reservoir 100 is joined to the passage forming substrate 10 provided with the piezoelectric elements 300, that is, to the lower electrode film 60, the elastic film 50, and the lead electrodes 90 through the adhesive 35. In this embodiment, the reservoir section 31 is perforated through the protective substrate 30 in the thickness direction thereof and formed in the width direction of the pressure generating chambers 12. In addition, as described above, the reservoir section communicates with the communication section 13 of the passage forming substrate 10 to form the reservoir 100 as the common ink chamber of the pressure generating chambers 12. Only the reservoir section 31 may be configured to serve as the reservoir by partitioning the communication section 13 of the passage forming substrate 10 in every pressure generating chamber 12. Alternatively, only the pressure generating chambers 12 are provided in the passage forming substrate 10 and the ink supply passages 14 communicating with the reservoir 100 and the pressure generating chambers 12 may be formed in members (for example, the elastic film 50, the insulating film 55, and the like) interposed between the passage forming substrate 10 and the protective substrate 30.

A piezoelectric element preserver 32 ensuring a space so as not to interrupt the movement of the piezoelectric elements 300 is formed in an area opposed to the piezoelectric elements 300 of the protective substrate 30. The piezoelectric element preserver 32 has the space so as not to interrupt the movement of the piezoelectric elements 300. In addition, the space may be sealed in an airtight manner or not sealed.

It is preferable that the protective substrate 30 is made of a material such as glass or a ceramic material having the almost same thermal expansibility as that of the passage forming substrate 10. In this embodiment, the protective substrate is formed of a silicon single crystal substrate which is the same material as that of the passage forming substrate 10.

A through-hole 33 perforated through the protective substrate 30 in the thickness direction thereof is formed in the protective substrate 30. The lead electrodes 90 are drawn from the piezoelectric elements 300, respectively, so that the vicinities of the ends thereof are exposed in the through-hole 33.

A driving circuit 120 for driving the piezoelectric elements 300 arranged in parallel is fixed onto the protective substrate 30. As the driving circuit 120, a circuit substrate or a semiconductor integrated circuit (IC) can be used, for example. The driving circuit 120 and the lead electrodes 90 are electrically connected to each other through connection wirings 121 formed of a conductive wire such as a bonding wire.

A compliance substrate 40 including a sealing film 41 and a fixing plate 42 is joined onto the protective substrate 30. The sealing film 41 is made of a material having a low rigidity and a flexible property. One surface of the reservoir section 31 is sealed by the sealing film 41. The fixing plate 42 is made of a material having a hard property. Since an area opposite the reservoir 100 of the fixing plate 42 is formed as an opening 43 completely removed in the thickness direction, one surface of the reservoir 100 is sealed only by the sealing film 41 having a flexible property.

In the ink jet print head according to this embodiment, ink is supplied from an ink introduction port connected to external ink supplying means (not shown), the inside from the reservoir 100 to the nozzle openings 21 is filled with the ink, and ink droplets are ejected from the nozzle openings 21 by applying voltage between the lower electrode film 60 and the upper electrode film 80 corresponding to each of the pressure generating chambers 12 in accordance with a print signal supplied from the driving circuit 120, deforming the elastic film 50, the insulating film 55, the lower electrode film 60, and the piezoelectric layer 70 so as to be bent, and increasing the pressure of each of the pressure generating chambers 12.

### (Method of Manufacturing Ink Jet Printing Head)

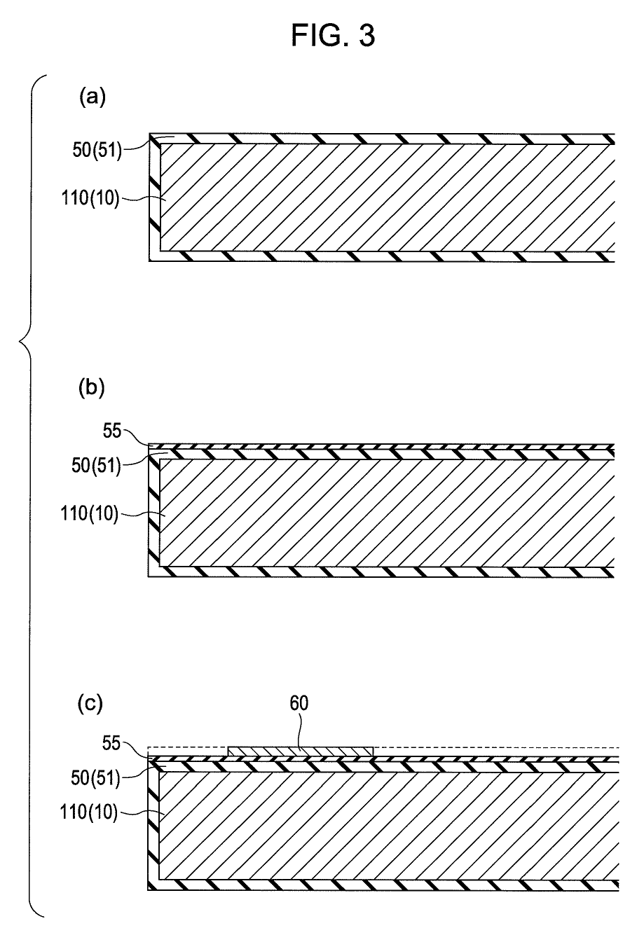

Hereinafter, a basic method of manufacturing the above-described ink jet printing head will be described with reference to FIGS. 3 to 7. FIGS. 3 to FIG. 7 are sectional views illustrating the method of manufacturing the ink jet printing head.

First, as shown in (a) of FIG. 3, a silicon dioxide film 51 formed of a silicon dioxide (SiO₂) and forming elastic film 50 is formed on the surface of the flow passage forming substrate wafer 110 as a silicon wafer which is formed integrally by the plurality of flow passage forming substrates 10. Subsequently, as shown in (b) of FIG. 3, the insulating film 55 made of zirconium oxide is formed on the elastic film 50 (the silicon dioxide film 51).

Subsequently, as shown in (c) of FIG. 3, the lower electrode film 60 is formed on the entire surface of the insulating film 55 and patterned in a predetermined shape. The material of the lower electrode film 60 is not particularly limited. However, when lead zirconate titanate (PZT) of the piezoelectric layer 70 is used, it is preferable that a material in which conductivity variation caused by diffusion of lead oxide is small is used. Therefore, as the material of the lower electrode film 60, platinum, iridium, or the like is preferred. In addition, the lower electrode film 60 can be formed by a sputtering method or a PVD method (Physical Vapor Deposition), for example.

Subsequently, the piezoelectric layer 70 made of lead zirconate titanate (PZT) is formed on the surface on which the lower electrode film 60 of the flow passage forming substrate wafer 110 is formed. In this embodiment, the piezoelectric layer 70 is formed by use of a so-called sol-gel method of applying and drying a so-called sol (application solution) obtained by dissolving and dispersing a metal organic substance with a solvent to make a gel and baking the gel at a high temperature to obtain the piezoelectric layer 70 made of metal oxide. The method of the manufacturing the piezoelectric layer 70 is not limited to the sol-gel method, but an MOD (Metal-Organic Decomposition) method may be used.

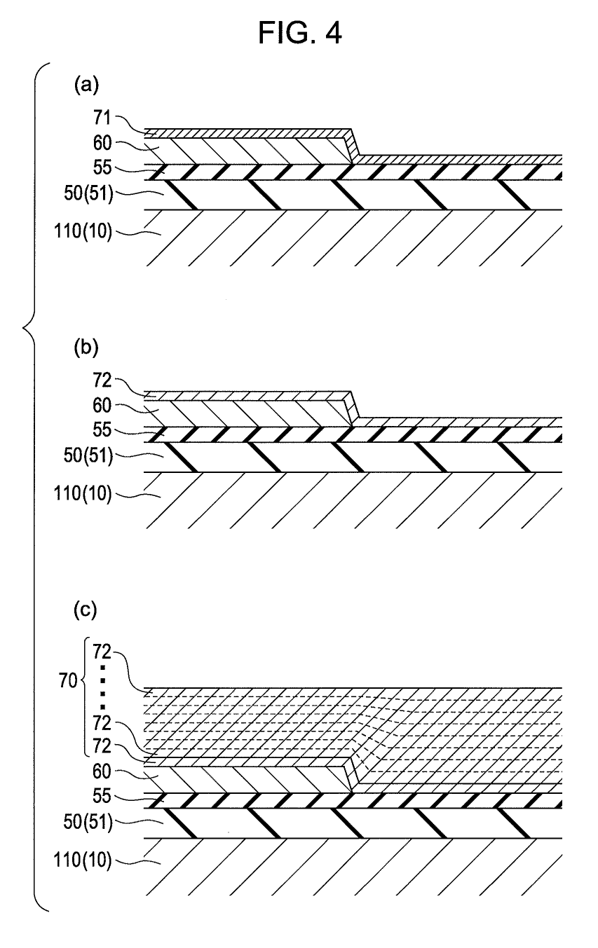

A specific sequence of manufacturing the piezoelectric layer 70 will be described. First, as shown in (a) of FIG. 4, the piezoelectric precursor film 71 as the PZT precursor film is formed on the lower electrode film 60. That is, a sol (application solution) containing the metal organic substance is applied onto the flow passage forming substrate 10 provided with the lower electrode film 60 (applying process). Subsequently, the piezoelectric precursor film 71 is heated at a predetermined temperature and dried for certain time (drying process). Subsequently, the dried piezoelectric precursor film 71 is heated at a predetermined temperature to remove fat and maintained for certain time (fat-removing process). Subsequently, as shown in (b) of FIG. 4, the piezoelectric precursor film 71 is crystallized by heating the piezoelectric precursor film at a predetermined temperature and maintaining the predetermined temperature for certain time, and the piezoelectric film 72 is formed (baking process).

As a heating apparatus used in the drying process, the fat-removing process, and the baking process, an RTP (Rapid Thermal Processing) apparatus performing heating by emission of an infrared lamp can be used, for example.

The piezoelectric layer 70 obtained by laminating a plurality of the piezoelectric films 72 shown in (c) of FIG. 4 is formed by repeatedly performing the piezoelectric film forming process including the applying process, the drying process, the fat-removing process, and the baking process described above. For example, when the film thickness per one time application of sol is about 0.1 μm, the whole film thickness of the piezoelectric layer 70 constituted by twelve piezoelectric films 72 is about 1.2 μm.

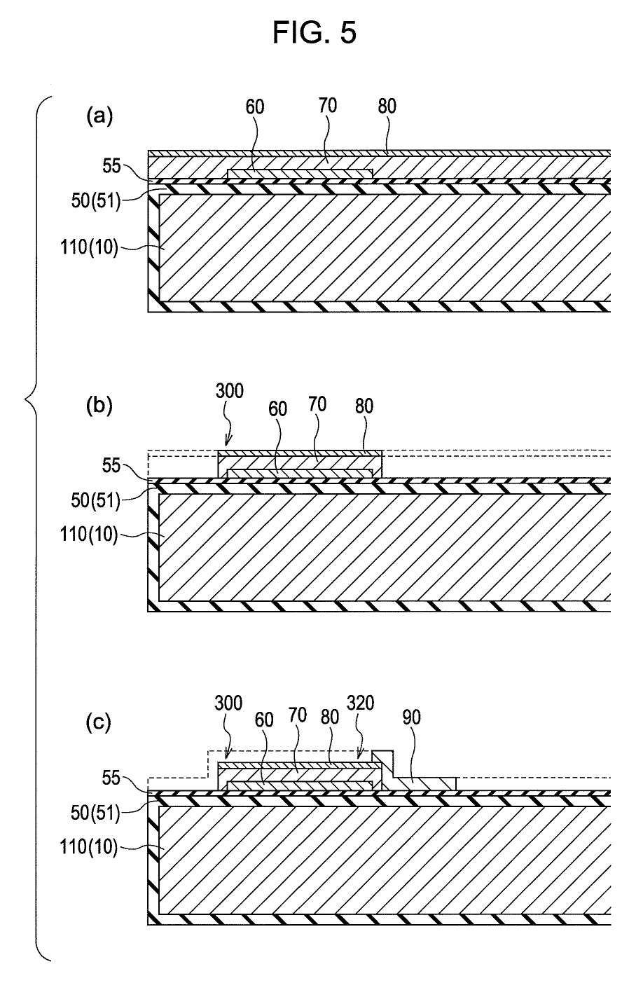

Subsequently, as shown in (a) of FIG. 5, the upper electrode film 80 made of iridium (Ir), for example, is formed across the piezoelectric layer 70. Subsequently, as shown in (b) of FIG. 5, the piezoelectric layer 70 and the upper electrode film 80 are patterned in an area opposite each of the pressure generating chambers 12 to form each of the piezoelectric elements 300. As a method of patterning the piezoelectric layer 70 and the upper electrode film 80, dry etching such as reactive ion etching or ion milling can be used.

Subsequently, the lead electrodes 90 are formed. Specifically, as shown in (c) of FIG. 5, the lead electrodes 90 are formed on the entire surface of the flow passage forming substrate wafer 110, and then each of the piezoelectric elements 300 are patterned through a master pattern (not shown) including a resist, for example.

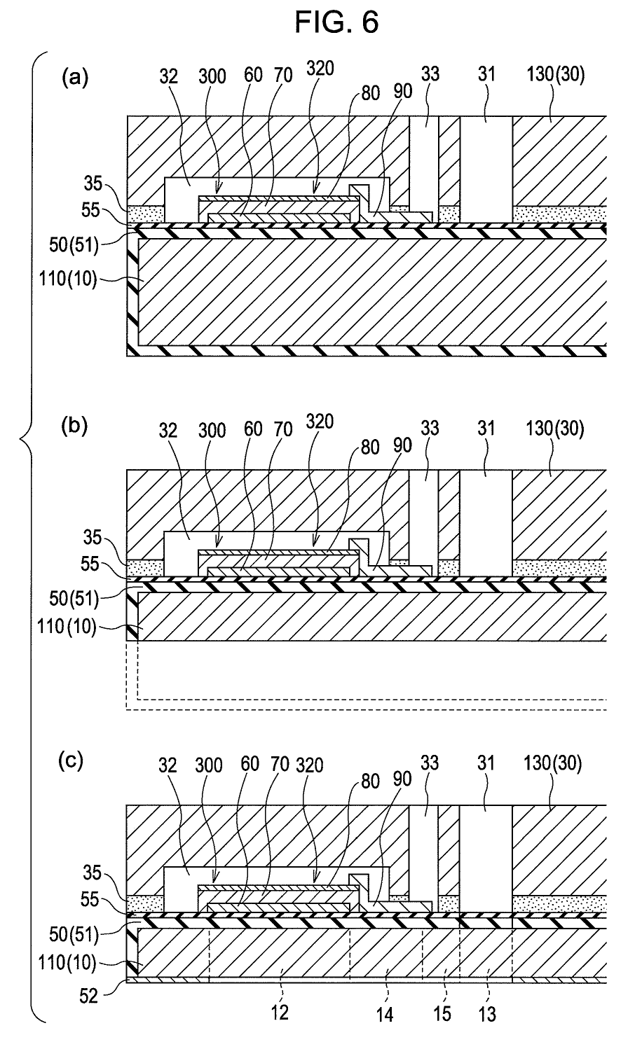

Subsequently, as shown in (a) of FIG. 6, the protective substrate wafer 130 which is a silicon wafer and a plurality of the protective substrates 30 is joined on a side of the piezoelectric elements 300 of the flow passage forming substrate wafer 110 through the adhesive 35.

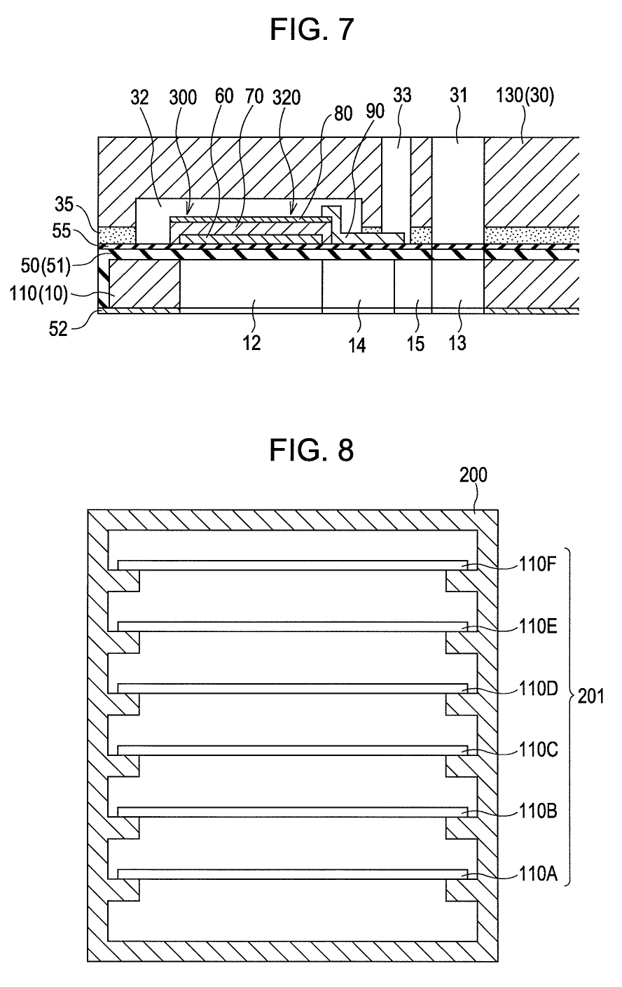

Subsequently, as shown in (b) of FIG. 6, the passage forming substrate wafer 110 is formed so as to have a predetermined thin thickness. Subsequently, as shown in (c) of FIG. 6, a mask film 52 is newly formed on the flow passage forming substrate wafer 110 and patterned in a predetermined shape. Subsequently, as shown in FIG. 7, the pressure generating chambers 12, the communication section 13, the ink supply passages 14, and the communication passages 15 individually corresponding to the piezoelectric elements 300 are formed by allowing the flow passage forming substrate wafer 110 to be subjected to anisotropic etching (wet etching) by use of an alkali solution such as KOH through the mask film 52.

Subsequently, unnecessary portions of the outer peripheries of the flow passage forming substrate wafer 110 and the protective substrate wafer 130 are cut and removed by dicing, for example. The nozzle plate 20 having the nozzle openings 21 punched therethrough is joined onto the surface of the flow passage forming substrate wafer 110 opposite the protective substrate wafer 130, the compliance substrate 40 is joined to the protective substrate wafer 130, and the flow passage forming substrate wafer 110 is divided into the passage forming substrates 10 having one chip size, as in FIG. 1, to manufacture the ink jet print head.

### First Embodiment

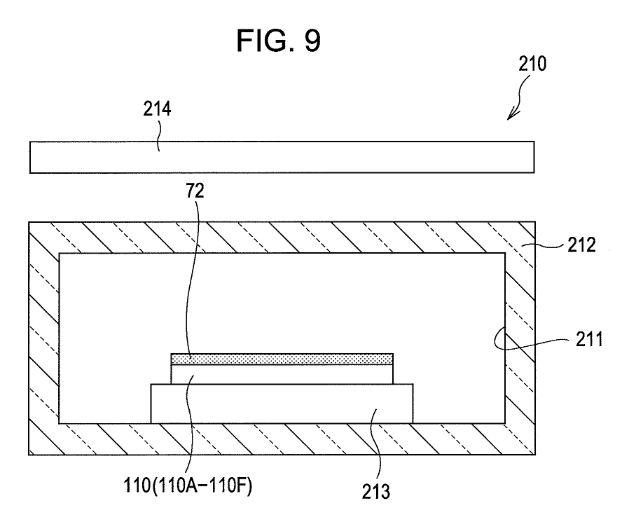

Hereinafter, a method of manufacturing an ink jet printing head according to the first embodiment of the invention will be described. FIG. 8 is a sectional view illustrating a wafer cartridge. FIG. 9 is a sectional view illustrating a heating apparatus.

The process of forming the piezoelectric layer 70 according to this embodiment is simultaneously performed in the flow passage forming substrate wafer group constituted by the plurality of flow passage forming substrate wafers 110. For example, as shown in FIG. 8, a plurality of flow passage forming substrate wafers, that is, six flow passage forming substrate wafers 110A to 110F are received in the wafer cartridge 200 to constitute a flow passage forming substrate wafer group 201 in this embodiment. The flow passage forming substrate wafers 110A to 110F are taken out one by one from the flow passage forming substrate wafer group 201 of the wafer cartridge 200 to form the piezoelectric film 72 on each of the taken-out flow passage forming substrate wafers 110A to 110F.

Here, the heating apparatus for forming the piezoelectric film 72 by heating the piezoelectric precursor film 71 on each of the flow passage forming substrate wafers 110A to 110F will be described. As shown in FIG. 9, a heating apparatus 210 includes a main body 212 having a space serving as a heating chamber 211 therein, a table 213 provided in the heating chamber 211 and holding the flow passage forming substrate wafers 110A to 110F, and a heating unit 214 provided outside the main body 212 and heating the piezoelectric precursor film 71.

The main body 212 is provided with the heating chamber 211 having a hollow portion therein and is made of a material such as glass which permits transferring heat from the heating unit 214 provided in the outside.

The table 213 provided in the heating chamber 211 of the main body 212 holds the flow passage forming substrate wafers 110A to 110F on one surface. The heating unit 214 heats the flow passage forming substrate wafer 110A to 110F (the piezoelectric precursor film 71) provided in the heating chamber 211 through the main body 212. For example, an infrared lamp such as a halogen lamp emitting an infrared ray can be used as the heating unit.

When the heating apparatus 210 allows the heating unit 214 to emit the infrared ray to heat the piezoelectric precursor film formed on each of the flow passage forming substrate wafers 110A to 110F placed inside the heating chamber 211, the piezoelectric precursor film 71 is crystallized to become the piezoelectric film 72. In addition, in the heating apparatus 210 according to this embodiment, the inside of the heating chamber 211 is not controlled so as to be typically maintained at a uniform heating temperature. After the flow passage forming substrate wafers 110A to 110F are placed inside the heating chamber 211, the heating is started by the heating unit 214. Therefore, when the flow passage forming substrate wafers 110A to 110F are taken out from the heating apparatus 210, the heating unit 214 does not perform heating and thus the temperature of the heating chamber 211 drops to the normal temperature.

When the piezoelectric film 72 is formed by the heating apparatus 210, the flow passage forming substrate wafers 110A to 110F received by the wafer cartridge 200 are sequentially transported to the heating apparatus 210 by a transport arm (not shown) and are heated to form the piezoelectric film 72.

At this time, in the flow passage forming substrate wafer group 201 constituted by the plurality of the flow passage forming substrate wafers 110A to 110F, the piezoelectric films 72 are formed one by one on each of the flow passage forming substrate wafers 110A to 110F. That is, after a first piezoelectric film 72 is formed by heating the piezoelectric precursor film 71 of a first flow passage forming substrate wafer 110A, the first piezoelectric film 72 is formed by heating the piezoelectric precursor film 71 of a second flow passage forming substrate wafer 110B. In this way, since the piezoelectric precursor film 71 is formed on the second flow passage forming substrate wafer 110B at the time of forming the piezoelectric film 72 on the first flow passage forming substrate wafer 110A by heating, the plurality of piezoelectric film 72 can be effectively formed.

By repeatedly performing the process of forming the piezoelectric film 72 by heating the piezoelectric precursor film 71 on the flow passage forming substrate wafers 110A to 110F, it is possible to form the piezoelectric layer 70 constituted by the plurality of piezoelectric films 72. Here, the process of heating and crystallizing the piezoelectric precursor film 71 to form the piezoelectric film 72, that is, the baking process has been described. However, since the piezoelectric precursor film 71 is heated in each of the drying process, the fat-removing process, and the baking process described above, the drying process, the fat-removing process, and the baking process may continue to be performed one time by the heating apparatus 210 at the time of forming the first piezoelectric film 72. Alternatively, each process of heating the flow passage forming substrate wafers 110A to 110F of the flow passage forming substrate wafer group 201 in order may be performed.

In this embodiment, when the piezoelectric films 72 are formed one by one on each of the flow passage forming substrate wafers 110A to 110F of the flow passage forming substrate wafer group 201, the heating process is performed on the flow passage forming substrate wafer group 201 by varying the order of the flow passage forming substrate wafers 110A to 110F for starting the formation of each piezoelectric film 72 by the predetermined number of wafers.

That is, for example, when twelve piezoelectric films 72 are formed, the formation of a first piezoelectric film 72 is started from the flow passage forming substrate wafer 110A, and then is performed in order of the flow passage forming substrate wafers 110B, 110C, 110D, 110E, and 110F.

Next, when a second piezoelectric film 72 is formed, the formation of a second piezoelectric film 72 is started from the flow passage forming substrate wafer 110B, and then is performed in order of the flow passage forming substrate wafers 110C, 110D, 110E, 110F, and 110A.

Next, when a third piezoelectric film 72 is formed, the formation of a third piezoelectric film 72 is started from the flow passage forming substrate wafer 110C, and then is performed in order of the flow passage forming substrate wafers 110D, 110E, 110F, 110A, and 110B. Likewise, when the piezoelectric films 72 subsequent to the third piezoelectric film are formed, the order of the flow passage forming substrate wafers 110A to 110F for starting the formation of each piezoelectric film 72 is varied.

In this embodiment, since the twelve piezoelectric films 72 are formed on the six flow passage forming substrate wafers 110A to 110F, the process of forming each of the piezoelectric films 72 on the flow passage forming substrate wafers 110A to 110F is circulated twice.

In this way, by varying the order of the flow passage forming substrate wafers 110A to 110F for starting the formation of each piezoelectric film 72, it is possible to prevent occurrence of a deviation in heat history of the piezoelectric film 72 and the lower electrode film 60 simultaneously heated with the piezoelectric film 72 between the flow passage forming substrate wafers 110. Accordingly, the heat history of the piezoelectric film 72 and the lower electrode film 60 can be made uniform between the flow passage forming substrate wafers 1110.

Additionally, when the formation of the piezoelectric films 72 is typically started from the predetermined flow passage forming substrate wafer 110A, the deviation in the heat history of the piezoelectric layer 70 and the lower electrode film 60 formed on each of the flow passage forming substrate wafers 110A to 110F may occur. It is considered that the deviation in the heat history of the piezoelectric layer 70 and the lower electrode film 60 occurs when the heat generated at the time of forming all the previous piezoelectric films 72 remains within the heating chamber 211, and a temperature at the time of forming the subsequent piezoelectric film 72 is higher than the normal temperature. Accordingly, in this embodiment, by varying the order of the flow passage forming substrate wafers 110A to 110F for starting the formation of each piezoelectric film 72, an influence of the heat generated at the time of the previous piezoelectric film 72 can be made uniform between the plurality of flow passage forming substrate wafers 110A to 110F. Therefore, the deviation in the heat history of the piezoelectric film 72 and the lower electrode film 60 can be prevented from occurring, and thus the heat history of the piezoelectric film 72 and the lower electrode film 60 can be made uniform between the flow passage forming substrate wafers 110. In this way, the characteristics of the piezoelectric layer 70 or the lower electrode film 60 under the influence of the heat history, that is, piezoelectric characteristics such as anti-electric field or leakage current of the piezoelectric layer 70 or the characteristics of the piezoelectric element 300 as the characteristics such as sheet resistance of the simultaneously heated lower electrode can be made uniform.

Moreover, when the flow passage forming substrate wafers 110A to 110F are separated to form the ink jet printing head having one chip size like the above-described manufacturing method, the characteristics of the piezoelectric elements 300 can be made uniform by allowing the heat history of the piezoelectric layer 70 and the lower electrode film 60 to be uniform in the ink jet printing heads separated from the plurality of flow passage forming substrate wafers 110A to 110F, and thus an ink ejection characteristic can be made uniform. Accordingly, when the plurality of ink jet printing heads are combined to be mounted on the ink jet printing apparatus or the like, it is possible to improve a print quality by allowing the ink ejection characteristic to be uniform. Moreover, it is possible to simplify the manufacturing process, since a work for distinguishing the ink jet printing heads on the basis of the ink ejection characteristic and combining the ink jet printing heads having the same ink ejection characteristic is not necessary.

In this embodiment, the twelve piezoelectric films 72 are formed on the flow passage forming substrate wafer group 201 constituted by the six flow passage forming substrate wafers 110A to 110F. However, the number of the flow passage forming substrate wafers 110 constituting the flow passage forming substrate wafer group 201 and the number of the laminated piezoelectric films 72 are not limited thereto.

For example, when six piezoelectric films 72 are formed on each of twelve flow passage forming substrate wafers 110, the order of the flow passage forming substrate wafers 110 for starting the formation of the piezoelectric films 72 may be varied every two wafers.

Alternatively, when four piezoelectric films 72 are formed on each of twelve flow passage forming substrate wafers 110, the order of the flow passage forming substrate wafers 110 for starting the formation of each piezoelectric film 72 may be varied every three wafers.

That is, when the flow passage forming substrate wafer group 201 is constituted by the flow passage forming substrate wafers 110 of which the number is an n (where n is an integer) multiple of the number of laminated piezoelectric films 72, the order of the flow passage forming substrate wafers 110 for starting the formation of each piezoelectric film 72 in the flow passage forming substrate wafer 110 may be varied by the n number of wafers.

Of course, even when the flow passage forming substrate wafer group 201 is constituted by the flow passage forming substrate wafers 110 of which the number is a multiple other than n (where n is an integer) multiple of the number of laminated piezoelectric films 72, the order of the flow passage forming substrate wafers may be varied every two wafers. That is, even when five piezoelectric films 72 are formed on each of twelve flow passage forming substrate wafers 110, for example, the order of the flow passage forming substrate wafers 110 for starting the formation of each piezoelectric film 72 may be varied every two wafers.

Alternatively, when eleven piezoelectric films 72 are formed on each of twelve flow passage forming substrate wafers 110, for example, the order of the flow passage forming substrate wafers 110 for starting the formation of each piezoelectric film 72 may be varied every one wafer. That is, when the flow passage forming substrate wafer group 201 is constituted by the flow passage forming substrate wafers 110 of which the number is equal to or smaller than the number of piezoelectric precursor films 71 laminated on each of the flow passage forming substrate wafers 110, the order of the flow passage forming substrate wafers 110 for starting the formation of each piezoelectric film 72 may be varied every one wafer.

In this way, when the order of the plurality of flow passage forming substrate wafers 110 for starting the formation of each piezoelectric film 72 is equalized in the plurality of flow passage forming substrate wafers 110, the heat history of the piezoelectric layer 70 and the lower electrode film 60 formed between the plurality of flow passage forming substrate wafers 110 can be made uniform. Therefore, the characteristics of the piezoelectric elements 300 can be made uniform.

### Second Embodiment

Hereafter, a method of manufacturing an ink jet printing head will be described according to a second embodiment of the invention.

In the process of forming the piezoelectric layer 70 according to this embodiment, particularly in the process of heating the piezoelectric precursor films 71 to form the piezoelectric films 72, the heating is performed by rotating each of the flow passage forming substrate wafers at a predetermined angle in an in-plane direction of the flow passage forming substrate wafer within the heating chamber at the time of forming each of the piezoelectric films 72.

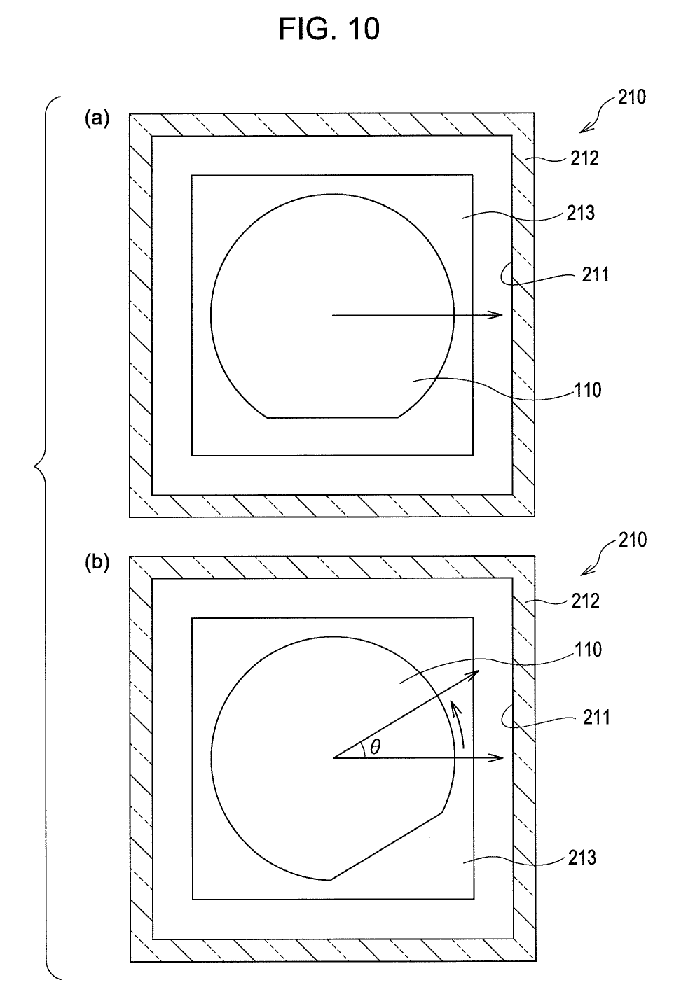

That is, after the first piezoelectric film 72 is formed on the flow passage forming substrate wafer 110, as shown in (a) of FIG. 10, the heating is performed by rotating the flow passage forming substrate wafer 110 at an angle θ in the plane direction at the time of forming the second piezoelectric film 72, as shown in (b) of FIG. 10. For example, when twelve piezoelectric films 72 are formed on each of the flow passage forming substrate wafers 110, the piezoelectric film 72 is formed by rotating each of the flow passage forming substrate wafers 110 at thirty degrees.

For example, when six piezoelectric films 72 are formed on each of the flow passage forming substrate wafers 110, the piezoelectric film 72 is formed by rotating each of the flow passage forming substrate wafers 110 at sixty degrees. That is, when each of the flow passage forming substrate wafers is rotated at an angle obtained by dividing 360 degrees as one rotation by the number of piezoelectric films 72 laminated on the flow passage forming substrate wafer 110, the flow passage forming substrate wafer 110 is rotated one time at the time of finishing the formation of the plurality of piezoelectric films 72.

By rotating the flow passage forming substrate wafer 110 at the predetermined angle in the in-plane direction of the flow passage forming substrate wafer 110 to arrange the flow passage forming substrate wafer within the heating chamber 211 at the time of heating the piezoelectric precursor films 71 in the process of forming the piezoelectric films 72 to be laminated, it is possible to prevent the deviation in the heat history of the piezoelectric films 72 and the lower electrode film 60 simultaneously heated therewith in the plane of the flow passage forming substrate wafer 110. Therefore, the heat history of the piezoelectric films 72 and the lower electrode film 60 in the plane of the flow forming substrate wafer 110 can be made uniform. Additionally, it is difficult to maintain a uniform temperature in the whole areas of the heating chamber 211 and the temperature is different in the area of the heating chamber 211. For that reason, when the flow passage forming substrate wafers 110 are typically arranged at the same angle within the heating chamber 211 to perform the heating in the process of heating and forming the plurality of piezoelectric films 72, the deviation in the heat history of the piezoelectric films 72 and the lower electrode film 60 may occur.

In this embodiment, by rotating the flow passage forming substrate wafer 110 at the predetermined angle in the plane direction of the flow passage forming substrate wafer 110 to arrange the flow passage forming substrate wafer within the heating chamber 211 in the process of heating each of the piezoelectric precursor film 71, it is possible to prevent the deviation in the heat history of the piezoelectric films 72 and the lower electrode film 60 simultaneously heated therewith in the plane of the flow passage forming substrate wafer 110. Therefore, the heat history of the piezoelectric films 72 and the lower electrode film 60 in the plane of the flow forming substrate wafer 110 can be made uniform. In this way, the characteristics of the piezoelectric layer 70 or the lower electrode film 60 under the influence of the heat history in the flow passage forming substrate wafer 110, that is, piezoelectric characteristics such as anti-electric field or leakage current of the piezoelectric layer 70 or the characteristics of the piezoelectric element 300 as the characteristics such as sheet resistance of the simultaneously heated lower electrode can be made uniform.

Moreover, when the flow passage forming substrate wafers 110 are separated to form the ink jet printing head having one chip size like the above-described manufacturing method, the piezoelectric characteristics of the piezoelectric elements 300 can be made uniform in the plurality of ink jet printing heads separated from the flow passage forming substrate wafer 110, and thus the ink ejection characteristic can be made uniform. Accordingly, when the plurality of ink jet printing heads are combined to be mounted on the ink jet printing apparatus or the like, it is possible to improve the print quality by allowing the ink ejection characteristic to be uniform. Moreover, it is possible to simplify the manufacturing process, since a troublesome work for distinguishing the ink jet printing heads on the basis of the ink ejection characteristic and combining the ink jet printing heads having the same ink ejection characteristic is not necessary.

In order to arranging the flow passage forming substrate wafer 110 at the predetermined angle within the heating chamber 211, rotation means may be provided in a transport arm and the flow passage forming substrate wafer 110 may be rotated by the rotation means at the time of arranging the flow passage forming substrate wafer within the heating chamber 211, for example. Alternatively, the flow passage forming substrate wafer 110 may be rotated by the rotation means at the time of returning the flow passage forming substrate wafer to the wafer cartridge 200. Of course, the wafer cartridge 200 may be provided with rotation means.

In this embodiment, the flow passage forming substrate wafer 110 is rotated at the predetermined angle θ to form each of the piezoelectric films 72. However, the table 213 may be rotatably provided and the flow passage forming substrate wafer 110 may be rotated while the piezoelectric precursor film 71 is heated, for example.

### Other Embodiments

The embodiment of the invention has been described, but the invention is not limited to the above-described embodiment in the basic configuration. For example, by combining the first and second embodiments described above, the piezoelectric characteristics of the piezoelectric elements 300 between the plurality of flow passage forming substrate wafers 110 and 110A to 110F can be made uniform and the piezoelectric characteristics of the piezoelectric elements 300 in the plane of each of the flow passage forming substrate wafers 110 and 110A to 110F can be made uniform. That is, when the piezoelectric films 72 are formed one by one on each of the flow passage forming substrate wafers 110A to 110F of the flow passage forming substrate wafer group 201, the order of the flow passage forming bard wafers 110A to 110F for starting the formation of each piezoelectric film 72 may be varied by the predetermined number of wafers of the flow passage forming substrate wafer group 201, as described in the first embodiment. In addition, when each of the piezoelectric films 72 are formed on each of the flow passage forming substrate wafers 110A to 110F, the flow passage forming substrate wafer 110 may be rotated at the predetermined angle, as described in the second embodiment. In this way, when the ink jet printing heads having one chip size are formed form the plurality of flow passage forming substrate wafers 110 and 110A to 110F, the characteristics of the piezoelectric elements 300 can be made uniform, and thus the ink ejection characteristic can be made uniform in each of the ink jet printing heads.

In the above-described method of manufacturing the ink jet printing head, the piezoelectric layer 70 is formed after patterning the lower electrode film 60. However, in terms of the relation with a device, the lower electrode film 60 may be patterned along with the piezoelectric film 72, after the first piezoelectric film 72 is formed on the lower electrode film.

In the above-described first embodiment, the piezoelectric film 72 is formed after performing the applying process, the drying process, the fat-removing process, and the baking process on the piezoelectric precursor film 71. However, the invention is not limited thereto. For example, after the applying process, the drying process, and the fat-removing process on the piezoelectric precursor film 71 are performed plural times, for example, twice times, the piezoelectric film 72 may be formed by simultaneously baking the second piezoelectric precursor film 71.

In the above-described first embodiment, the silicon single crystal substrate is used as the flow passage forming substrate 10, but the invention is not particularly limited thereto. For example, a material such as an SOI substrate or glass may be used.

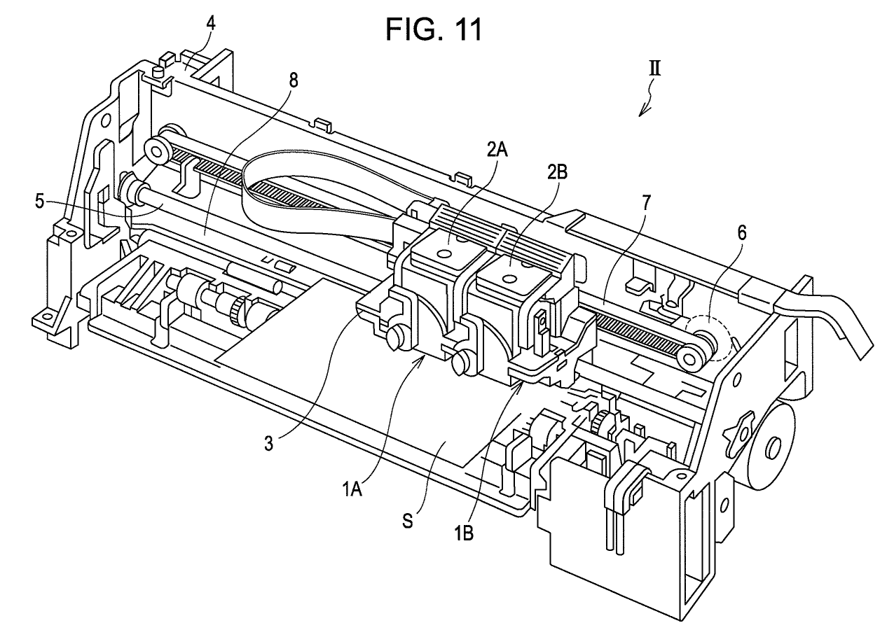

The above-described ink jet printing head I forms a part of a printing head unit having the ink passage communicating with the ink cartridge or the like and is mounted on the ink jet printing apparatus. FIG. 11 is a schematic diagram illustrating an example of the ink jet printing apparatus.

In an inkjet printing apparatus II shown in FIG. 11, printing head units 1A and 1B each having an ink jet printing head I are provided so that cartridges 2A and 2B forming an ink supply unit are detachably mounted, respectively. A carriage 3 mounted with the printing head units 1A and 1B is provided to freely move along a carriage shaft 5 attached to an apparatus main body 4 in a shaft direction. The printing head units 1A and 1B are each configured to eject black ink and color ink, for example.

The carriage 3 mounting the printing head units 1A and 1B is moved along the carriage shaft 5 by delivering a driving force of a driving motor 6 to the carriage 3 through a plurality of toothed-gears (not shown) and a timing belt 7. On the other hand, a platen 8 is formed along the carriage shaft 5 in the apparatus main body 4. In addition, a printing sheet S as a printing medium such as a paper sheet fed by a sheet feeding roller (not shown) or the like is wound by the platen 8 so as to be transported.

In the above-described ink jet printing apparatus II, the ink jet printing heads I (the head units 1A and 1B) are mounted on the carriage 3 and moved in a main scanning direction, but the invention is not particularly limited thereto. For example, the invention is applicable to a so-called line type ink jet printing apparatus in which the ink jet print heads I is fixed and printing is performed just by moving a print sheet S such as a paper sheet in a sub-scanning direction.

In the above-described example, the ink jet printing head has been described as an example of the liquid jet head. However, the invention is devised so as to be applied to various liquid jet heads. Of course, the invention is applicable to a liquid jet head or a liquid jet apparatus for ejecting a liquid other than ink. Examples of the liquid jet head include various printing heads used for an image printing apparatus such as a printer, a color material jet head used to manufacture a color filter such as a liquid crystal display, an electrode material jet head used to form electrodes such as an organic EL display or an FED (Field Emission Display), and a bio organism jet head used to manufacture a bio chip. Moreover, the invention is applicable to these liquid jet apparatuses including these liquid jet heads.

The invention is not limited to the method of manufacturing the piezoelectric element mounted on the ink jet print head which is a representative example of the liquid jet head, but may be a method of manufacturing a piezoelectric element mounted on other apparatuses.

1. A method of manufacturing a liquid jet head, comprising the steps of:
forming a lower electrode on one surface of a flow passage forming substrate wafer in which a plurality of flow passage forming substrates each provided with pressure generating chambers individually communicating with nozzle openings for ejecting a liquid are integrally formed;
forming a piezoelectric layer, in which a plurality of piezoelectric films are laminated by repeatedly performing a step of forming a piezoelectric precursor film to be turned into the piezoelectric film and a step of forming a piezoelectric film has a step of placing the flow passage forming substrate wafer within a heating chamber and a step of heating the piezoelectric precursor film to form the piezoelectric film, on the lower electrode side of the flow passage forming substrate wafer; and
forming an upper electrode on the piezoelectric layer,
wherein in the step of heating the piezoelectric precursor film, the piezoelectric films are formed one by one on each of the plurality of flow passage forming substrate wafers constituting a flow passage forming substrate wafer group, and an order of the flow passage forming substrate wafers for starting the heating of each piezoelectric precursor film is varied by the predetermined number of wafers of the flow passage forming substrate wafer group.

2. The method according to claim 1, wherein when the flow passage forming substrate wafer group is constituted by the flow passage forming substrate wafers of which the number is equal to or smaller than the number of piezoelectric films laminated on each of the flow passage forming substrate wafers, the order of the flow passage forming substrate wafers for starting the heating of each piezoelectric precursor film is varied by one wafer.

3. The method according to claim 1, wherein when the flow passage forming substrate wafer group is constituted by the flow passage forming substrate wafers of which the number is an n (where n is an integer) multiple of the number of piezoelectric films laminated on each of the flow passage forming substrate wafers, the order of the flow passage forming substrate wafers for starting the heating of each piezoelectric precursor film is varied by the n number of wafers.

4. The method according to claim 1, wherein in the step of laminating the piezoelectric films, the flow passage forming substrate wafer is rotated at a predetermined angle in an in-plane direction of the flow passage forming substrate wafer to be disposed within the heating chamber in the heating of each piezoelectric precursor film.

5. The method according to claim 1, wherein in the step of laminating the piezoelectric films, the flow passage forming substrate wafer is heated within the heating chamber while being rotated in an in-plane direction of the flow passage forming substrate wafer.

6. A method of manufacturing a liquid jet head, comprising the steps of:
forming a lower electrode on one surface of a flow passage forming substrate wafer in which a plurality of flow passage forming substrates each provided with pressure generating chambers individually communicating with nozzle openings for ejecting a liquid are integrally formed;
forming a piezoelectric layer, in which a plurality of piezoelectric films are laminated by repeatedly performing a step of forming a piezoelectric precursor film to be turned into the piezoelectric film and a step of forming a piezoelectric film has a step of placing the flow passage forming substrate wafer within a heating chamber and a step of heating the piezoelectric precursor film to form the piezoelectric film, on the lower electrode side of the flow passage forming substrate wafer; and
forming an upper electrode on the piezoelectric layer,
wherein in the step of laminating the piezoelectric films, the flow passage forming substrate wafer is rotated at a predetermined angle in an in-plane direction of the flow passage forming substrate wafer to be arranged within the heating chamber in the heating of each piezoelectric precursor film.

7. A liquid jet apparatus comprising the liquid jet head according to claim 1.

8. A method of manufacturing a piezoelectric element, comprising the steps of:
forming a lower electrode on a substrate;
forming a piezoelectric layer, in which a plurality of piezoelectric films are laminated by repeatedly performing a step of forming a piezoelectric precursor film to be turned into the piezoelectric film and a step of forming a piezoelectric film has a step of placing the substrate within a heating chamber and a step of heating the piezoelectric precursor film to form the piezoelectric film, on the lower electrode of the substrate; and
forming an upper electrode on the piezoelectric layer,
wherein in the step of heating the piezoelectric precursor film, the piezoelectric films are formed one by one on each of the plurality of substrates constituting a substrate group, and an order of the substrates for starting the heating of each piezoelectric precursor film is varied by the predetermined number of substrates of the substrate group.

9. The method according to claim 8, comprising the steps of:
forming a lower electrode on a substrate;
forming a piezoelectric layer, in which a plurality of piezoelectric films are laminated by repeatedly performing a step of forming a piezoelectric precursor film to be turned into the piezoelectric film and a step of forming a piezoelectric film has a step of placing the substrate within a heating chamber and a step of heating the piezoelectric precursor film to form the piezoelectric film, on the lower electrode of the substrate; and
forming an upper electrode on the piezoelectric layer,
wherein in the step of laminating the plurality of piezoelectric films, the substrate is rotated at a predetermined angle in an in-plane direction of the flow passage forming substrate wafer to be disposed within the heating chamber in the heating of each piezoelectric precursor film.
